(19) United States
(12) Patent Application Publication
(10) Pub. No.: US 2024/0148184 A1
(43) Pub. Date: May 9, 2024

(54) CONNECTION STRUCTURE OF GRILL STOVE

(71) Applicant: REVOACE INC.LIMITED, Hong Kong (CN)

(72) Inventor: Kiosky Chung, Hong Kong (CN)

(21) Appl. No.: 17/984,040

(22) Filed: Nov. 9, 2022

(51) Int. Cl. A47J 37/07; F24C 15/00

(52) U.S. Cl. CPC A47J 37/07; F24C 15/007

(57) ABSTRACT

A connection structure of a grill stove contains: a first accommodation cylinder and a second accommodation cylinder. The first accommodation cylinder includes a receiving chamber, a circular hole configured to receive the second accommodation cylinder, and a mouth configured to communicate the receiving chamber with an external environment. The second accommodation cylinder is columnar and includes a circular cap configured to cover the circular hole, an arcuate casing aligned with or not aligned with the mouth by rotating the second accommodation cylinder with respect to the first accommodation cylinder. The second accommodation cylinder further includes a grilling chamber and multiple grill grids received in the grilling chamber. The grilling chamber is aligned with or is not aligned with the mouth by rotating the second accommodation cylinder with respect to the first accommodation cylinder.

### FIELD OF THE INVENTION

The present invention relates to a connection structure of a grill stove by which the first accommodation cylinder is aligned with or is not aligned with the second accommodation cylinder so as to open or close the opening of the grill stove.

### BACKGROUND OF THE INVENTION

Conventional grill stoves are disclosed in U.S. Pat. Nos. 5,222,475 and 8,230,848. These grill stoves contain multiple grilling chambers to grill food ingredients.

However, the conventional grill stoves are opened or closed by opening or closing a door, so it is dangerous to drop the grill stoves after the door is opened in a windy outdoors.

The present invention has arisen to mitigate and/or obviate the afore-described disadvantages.

### SUMMARY OF THE INVENTION

The primary aspect of the present invention is to provide a connection structure of a grill stove which contains the first accommodation cylinder and the second accommodation cylinder which is rotatable with respect to the first accommodation cylinder, and the first accommodation cylinder is aligned with or is not aligned with the second accommodation cylinder so as to open or close the opening of the grill stove.

Another aspect of the present invention is to provide a connection structure of a grill stove by which the fixing ring is detachable so as to remove the second accommodation cylinder from the first accommodation cylinder, thus cleaning the grill stove easily.

To obtain the above mentioned aspects, a connection structure of a grill stove provided by the present invention contains: a first accommodation cylinder and a second accommodation cylinder.

The first accommodation cylinder includes a receiving chamber formed in a cylinder shape, a circular hole defined on a top of the first accommodation cylinder, communicating with the receiving chamber, and configured to receive the second accommodation cylinder, and a mouth defined on a peripheral wall of the first accommodation cylinder and configured to communicate the receiving chamber with an external environment.

The second accommodation cylinder is columnar to correspond to a profile of the receiving chamber, and the second accommodation cylinder includes a circular cap mounted on a top thereof and configured to cover the circular hole, an arcuate casing fixed on a peripheral wall of the second accommodation cylinder. The arcuate casing is aligned with or is not aligned with the mouth by rotating the second accommodation cylinder with respect to the first accommodation cylinder.

The second accommodation cylinder further includes a grilling chamber defined on a portion thereof which is not shielded by the arcuate casing, and the second accommodation cylinder includes multiple grill grids received in the grilling chamber. The grilling chamber is aligned with or is not aligned with the mouth by rotating the second accommodation cylinder with respect to the first accommodation cylinder.

The second accommodation cylinder further includes multiple rollers arranged around a peripheral wall of the circular cap, and the first accommodation cylinder includes a guide rail formed around the circular hole of the first accommodation cylinder so that the multiple rollers slide on the guide rail.

The connection structure of the grill stove further contains a fixing ring configured to cover the circular cap and the first accommodation cylinder. The first accommodation cylinder includes two first retainers extending from a top of the peripheral wall of the first accommodation cylinder, such that the two first retainers are configured to fix the fixing ring on the first accommodation cylinder.

The second accommodation cylinder further includes two grips disposed on the circular cap thereof.

### BRIEF DESCRIPTION OF THE DRAWINGS

FIG. 1 is a perspective view showing the exploded components of a connection structure of a grill stove according to a preferred embodiment of the present invention.

FIG. 2 is a perspective view showing the operation of the connection structure of the grill stove according to the preferred embodiment of the present invention.

FIG. 3 is another perspective view showing the operation of the connection structure of the grill stove according to the preferred embodiment of the present invention.

FIG. 4 is a perspective view showing the exploded components of a first accommodation cylinder of the connection structure of the grill stove according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

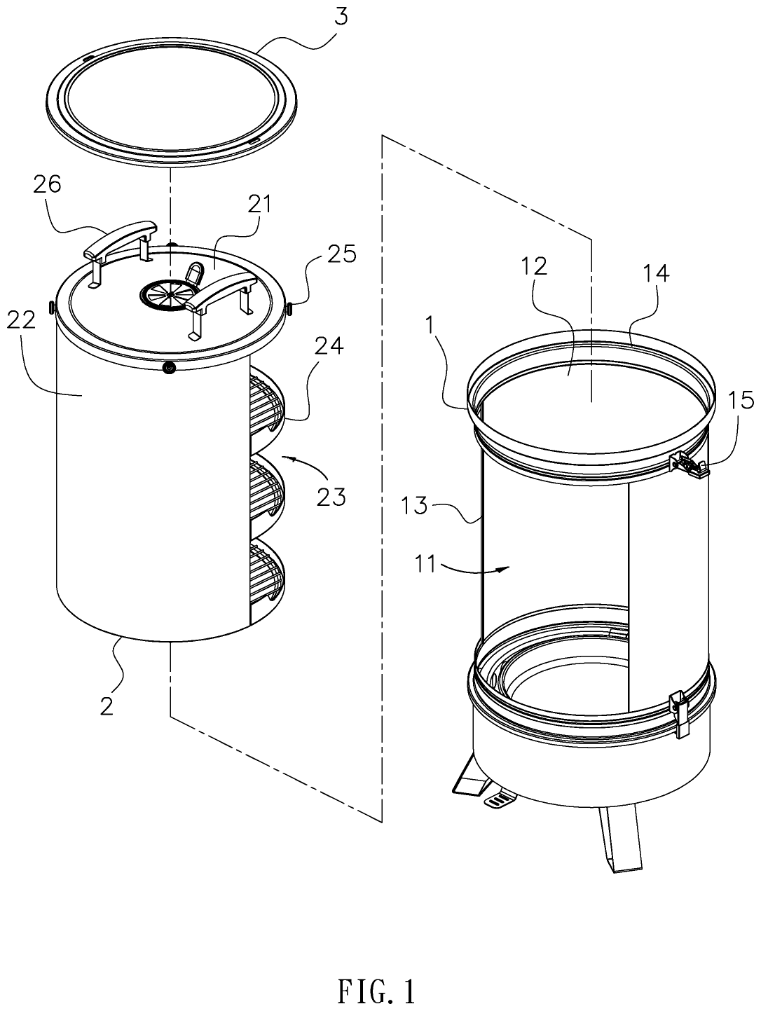

With reference to FIGS. 1-3, a connection structure of a grill stove according to a preferred embodiment of the present invention is capable of aligning and not aligning two accommodation cylinders of the grill stove to open or close an opening of the grill stove quickly. The connection structure of the grill stove comprises a first accommodation cylinder 1 and a second accommodation cylinder 2.

The first accommodation cylinder 1 includes a receiving chamber 11 formed in a cylinder shape, a circular hole 12 defined on a top of the first accommodation cylinder 1, communicating with the receiving chamber 11, and configured to receive the second accommodation cylinder 2, and a mouth 13 defined on a peripheral wall of the first accommodation cylinder 1 and configured to communicate the receiving chamber 11 with an external environment.

The second accommodation cylinder 2 is columnar to correspond to a profile of the receiving chamber 11, and the second accommodation cylinder 2 includes a circular cap 21 mounted on a top thereof and configured to cover the circular hole 12, an arcuate casing 22 fixed on a peripheral wall of the second accommodation cylinder 2, wherein the arcuate casing 22 is aligned with or is not aligned with the mouth 13 by rotating the second accommodation cylinder 2 with respect to the first accommodation cylinder 1. The second accommodation cylinder 2 further includes a grilling chamber 23 defined on a portion thereof which is not shielded by the arcuate casing 22, and the second accommodation cylinder 2 includes multiple grill grids 24 received in the grilling chamber 23, wherein the grilling chamber 23 is aligned with or is not aligned with the mouth 13 by rotating the second accommodation cylinder 2 with respect to the first accommodation cylinder 1.

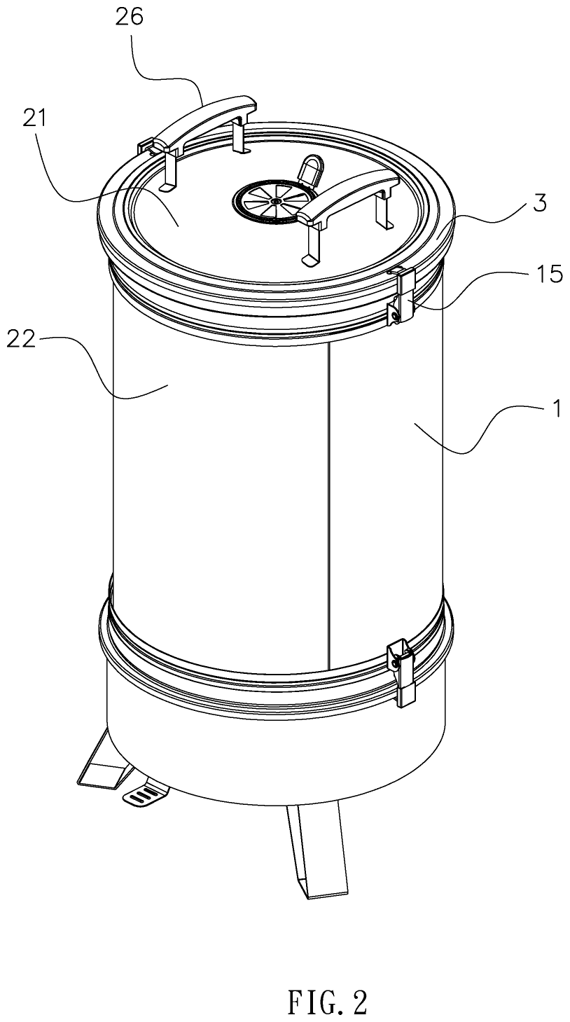

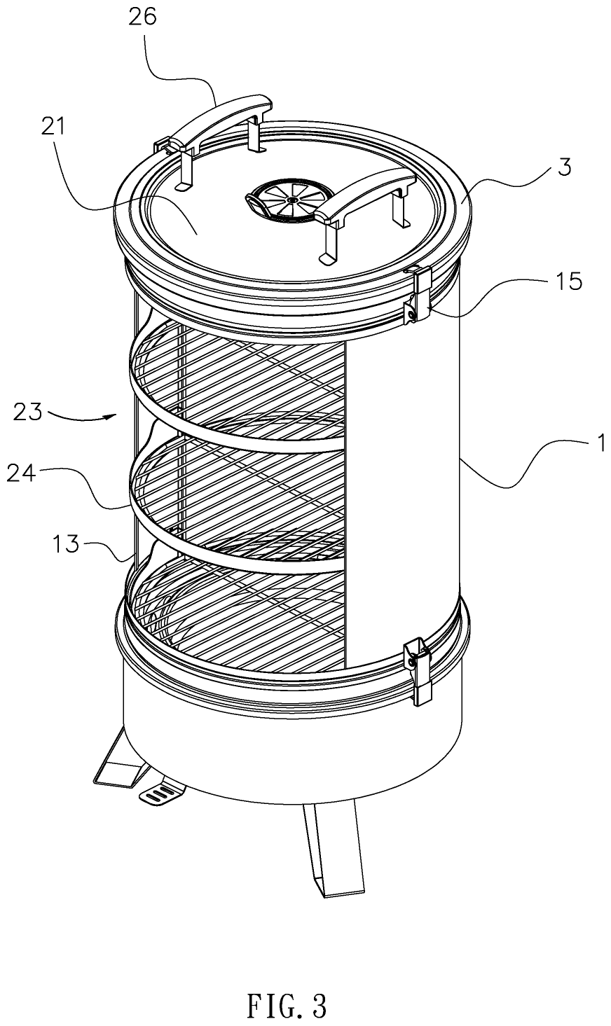

When the arcuate casing 22 is aligned with the mouth 13 by rotating the second accommodation cylinder 2 with respect to the first accommodation cylinder 1, the arcuate casing 22 shields the mouth 13, thus closing the grill stove, as shown in FIG. 2. When the second accommodation cylinder 2 is rotated with respect to the first accommodation cylinder 1, the grilling chamber 23 is aligned with the mouth 13 so as to open the grill stove, as illustrated in FIG. 3.

The second accommodation cylinder 2 further includes multiple rollers 25 arranged around a peripheral wall of the circular cap 21, and the first accommodation cylinder 1 includes a guide rail 14 formed around the circular hole 12 of the first accommodation cylinder 1 so that the multiple rollers 25 slide on the guide rail 14, hence the second accommodation cylinder 2 is rotated with respect to the first accommodation cylinder 1 by way of the multiple rollers 25 and the guide rail 14, thus opening or closing the opening of the grill stove easily.

The connection structure of the grill stove further comprises a fixing ring 3 configured to cover the circular cap 21 and the first accommodation cylinder 1, and the first accommodation cylinder 1 includes two first retainers 15 extending from a top of the peripheral wall of the first accommodation cylinder 1, such that the two first retainers 15 are configured to fix the fixing ring 3 on the first accommodation cylinder 1 so as to avoid a removal of the second accommodation cylinder 2 from the first accommodation cylinder 1.

The second accommodation cylinder 2 further includes two grips 26 disposed on the circular cap 21 and configured to rotate the circulate cap 21 and the second accommodation cylinder 2.

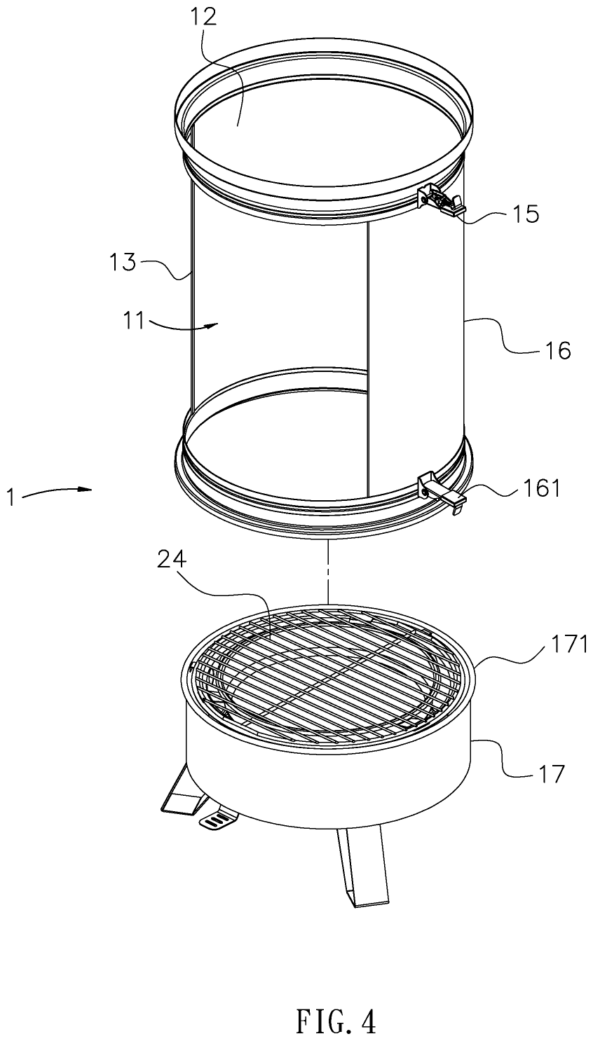

Referring to FIG. 4, the first accommodation cylinder 1 further includes an upper connection portion 16 and a lower connection portion 17 connected with and detached from the upper connection portion 16, wherein the receiving chamber 11, the circular hole 12 and the mouth 13 are located in the upper connection portion 16. The lower connection portion 17 has a recessed section formed on a top thereof and connected with a bottom of the upper connection portion 16, wherein the lower connection portion 17 also has an engagement rib 171 extending outward from an outer wall of a top thereof, and the upper connection portion 16 has two second retainers 161 extending from an outer wall of a bottom thereof and configured to engage with the engagement rib 17, such that when the two second retainers 161 are disengaged from the engagement rib 17, the upper connection portion 16 is detachable, and the multiple grill grids 24 are fixed on the top of the lower connection portion 17, thus obtaining barbecue.

Thereby, the connection structure of the grill stove comprises the first accommodation cylinder and the second accommodation cylinder which is rotatable with respect to the first accommodation cylinder, and the first accommodation cylinder is aligned with or is not aligned with the second accommodation cylinder so as to open or close the opening of the grill stove. Preferably, the fixing ring is detachable so as to remove the second accommodation cylinder from the first accommodation cylinder, thus cleaning the grill stove easily.

While various embodiments in accordance with the present invention have been shown and described, it is clear to those skilled in the art that further embodiments may be made without departing from the scope of the present invention.

What is claimed is:

1. A connection structure of a grill stove with a baking structure comprising: a first accommodation cylinder and a second accommodation cylinder;
wherein the first accommodation cylinder includes a receiving chamber formed in a cylinder shape, a circular hole defined on a top of the first accommodation cylinder, communicating with the receiving chamber, and configured to receive the second accommodation cylinder, and a mouth defined on a peripheral wall of the first accommodation cylinder and configured to communicate the receiving chamber with an external environment;
wherein the second accommodation cylinder is columnar to correspond to a profile of the receiving chamber, and the second accommodation cylinder includes a circular cap mounted on a top thereof and configured to cover the circular hole, an arcuate casing fixed on a peripheral wall of the second accommodation cylinder, wherein the arcuate casing is aligned with or is not aligned with the mouth by rotating the second accommodation cylinder with respect to the first accommodation cylinder;
wherein the second accommodation cylinder further includes a grilling chamber defined on a portion thereof which is not shielded by the arcuate casing, and the second accommodation cylinder includes multiple grill grids received in the grilling chamber, wherein the grilling chamber is aligned with or is not aligned with the mouth by rotating the second accommodation cylinder with respect to the first accommodation cylinder.

2. The connection structure of the grill stove as claimed in claim 1, wherein the second accommodation cylinder further includes multiple rollers arranged around a peripheral wall of the circular cap, and the first accommodation cylinder includes a guide rail formed around the circular hole of the first accommodation cylinder so that the multiple rollers slide on the guide rail.

3. The connection structure of the grill stove as claimed in claim 2 further comprising a fixing ring configured to cover the circular cap and the first accommodation cylinder, wherein the first accommodation cylinder includes two first retainers extending from a top of the peripheral wall of the first accommodation cylinder, such that the two first retainers are configured to fix the fixing ring on the first accommodation cylinder.

4. The connection structure of the grill stove as claimed in claim 1, wherein the second accommodation cylinder further includes two grips disposed on the circular cap thereof.
